(19) United States
(12) Patent Application Publication
(10) Pub. No.: US 2004/0089367 A1
(43) Pub. Date: May 13, 2004

(54) System for refilling bottled water reservoir in water station, from a bottle - bottle to bottle

(76) Inventor: Yair Buchsbaum, Givataim (IL)

Correspondence Address: YAIR BUCHSBAUM, 4, HAMALOT ST., GIVATAIM, 53258, IL

(21) Appl. No.: 10/428,679

(22) Filed: Apr. 29, 2003

(30) Foreign Application Priority Data
Jun. 27, 2002 (IL) IL-150442

(51) Int. Cl. B65B 31/00; B65B 3/04; B67C 3/00; B65B 1/04

(52) U.S. Cl. 141/18

(57) ABSTRACT

A water bottle refill system provided for use with a bottled water cooler having an upwardly open reservoir, receiving a supply of water from a bottle mounted over the reservoir in an inverted orientation. Such cooler and bottle are described, among others patents, in U.S. Pat. No. 6,167,921 and D. 339067.

The refill system provides the ability to transfer water to a bottle mounted on top of the cooler from a same or similar but water-full bottle, without the need to swap those heavy bottles, whilst assuring the purity and quality of water. The refill system keeps the accurate water-air balance by synchronizing air and water movements, thus normal operation of the cooler is maintained. The system allows different size bottles to be mounted on the cooler and be used as refill bottle.

### BACKGROUND OF THE INVENTION

This invention relates to water cooler or dispensers and related arts. More specifically, this invention provide a bottle water refill system, from a water-full bottle to a bottle on top of the cooler, which eliminates the tedious necessity of replacing heavy and clumsy bottles of water in the water cooler or dispenser. (class 222/251/417).

Conventional water coolers or dispensers include a source of bottled water, which is located on top and inverted upon a stand. More details may be achieved from U.S. Pat. Nos. 5,413,152/5,232,125/6,167,921.

Evidently, this requires continuous replacement of the bottle of water, which is heavy to carry, clumsy to turn upside-down, and complicated to accurately place at the right angle to avoid water spill.

Nevertheless, people tends to feel that bottled water are from higher quality than any tap water or even purified water employing different methods of filtering on-site.

The above water coolers or dispensers are designed to allow water, contained within the inverted bottle, to flow downwardly into and fill the reservoir. This downward water flow is accompanied by an upward exchange of air passing from the reservoir into the bottle to replace the volume of water discharged from the bottle. Any change in air pressure or water level that will not be balanced will cause an immediate leakage and harm the cooler operation.

To reduce the need for frequent bottle replacements with the conventional water cooler, big bottles, such as 5 gallons, are being used. This size in not an aesthetic sight and most users would prefer much smaller one.

This invention overcomes the above problems concerning most end-users, providing a simple, friendly system whilst maintaining water purity and water cooler normal operation as well as water supplier's interests.

The above, with other features and advantages of this invention, will be apparent to one familiar and skilled in the art in light of the details of the invention shown in the attached drawings and descriptions.

In short, this new invention uses controlled air movement, from the bottle on top of the cooler to the water-full (refilling) bottle, to transfer water from the refilling bottle to the bottle on the cooler. Water is transferred directly through a water pipe in a closed system, without any contact to foreign objects or even potentially contaminated air.

### SUMMARY OF THE INVENTION

In accordance with the invention, a refill system is provided for use with a bottled water cooler, from water-full bottle to bottle on the cooler. This system eliminates the need from water cooler's users to replace the bottle on top of the cooler when all water is discharged from it. It provides the easiest and cleanest way to transfer water from a sealed water bottle to the bottle on top of the cooler. The last is therefore becomes “fixed” or “needless-to-remove” bottle.

In the preferred form of the invention, an Air pipe is connected to the “fixed” bottle and to air pump. The air pump, electronically controlled, sucks the air from the bottle and simultaneity creates pressure in its outlet connected by an Air pipe to the refilling/water-full bottle.

Pressured air entering the water-full bottle, which is sealed appropriately, forces water to flow via a Water pipe, connected to the same bottle, to the “fixed” bottle on top of the cooler. Water has no contact with any foreign environment or objects, thus stays as pure as they come.

This operation takes place as a result of pushing start button, in manual mode, or, in optional automatic mode, when the minimum level of water in the cooler bottle reaches pre-defined level and activates a sensor.

The filling operation will cease as a result of one or more of the following:

1. Reaching pre-defined operational time, adjusted to the cooler bottle size.

2. Pushing a stop button.

3. Reaching maximum water level, in optional automatic mode.

4. Refilling bottle become empty.

The system assures that water-air balance fits with the cooler normal operation, prior to total halt of the filling process.

### BRIEF DESCRIPTION OF THE DRAWINGS

The accompanying drawings illustrate the invention. In such drawings:

FIG. 1 is an illustration of the system, via rear-view of a cooler, that is planned to be located within the water cooler, at the existing space beside the reservoir, the cooling and heating elements.

FIG. 2 is an illustration of the connection to the refilling/water-full bottle.

FIG. 3 is an illustration of the command panel.

FIG. 4 is a block diagram of main functions of the electronic controller.

### DETAILED DESCRIPTION OF THE PREFERED EMBODIMENTS

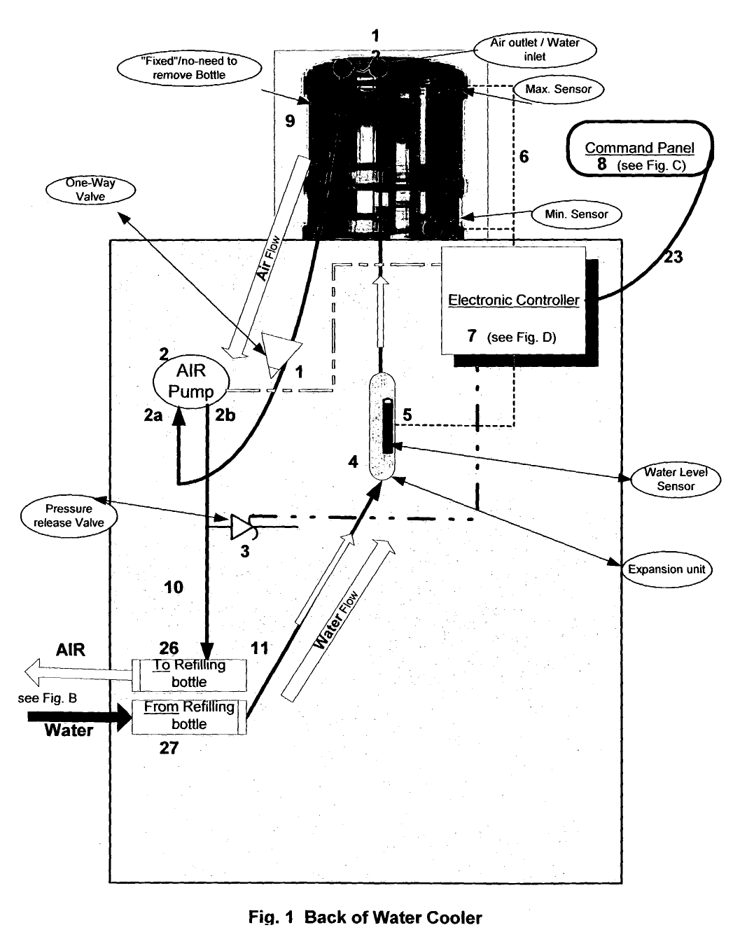

Referring to FIG. 1 of the drawings, the conventional bottle on top of the cooler (9) become “fixed” or “needless-to remove” bottle. This bottle is seating upside-down a cooler, usually equipped with a reservoir, chilling/cooling element and/or heating element (not shown).

The only change to the bottle (9) is two small holes (12) closest to its top. Each hole holds a rubber grommet that can be inserted from the outside and seals the holes from both sides whilst holding a pipe entering the inner side of the bottle.

One of the pipes is the AIR pipe that is connected, via a one-way unidirectional (non-returnable) valve (1) to a small air-pump (2) at its inlet nipple (2a). Air pump can be placed within the ample space exists in the cooler frame.

This nipple (2a) creates vacuum effect and sucks air from the bottle. The unidirectional one-way (1) valve assures proper flow of air in the desired direction—outward the bottle.

The outlet (2b) of the air-pump (2) creates pressure. The continuation of the air pipe (10) is connected to the outlet nipple (2b) and, at its other side, to a connector (26) leading to a refilling bottle (25).

Air-pump (2) operation is dependable of the electronic controller (7).

Connected to the air pipe (10) is a pressure release valve (3) that is controlled by the electronic controller (7) and is used to balance air-water pressures prior to stopping the pump (2) operation and returning to cooler normal operation.

From the refilling bottle (25) comes a Water pipe (11) via a connector (27) to an expansion unit (4). The expansion unit (4) also acts as a buffer, blocking any potential airflow from “fixed” bottle (9) via the water pipe, and as a platform to insert a water level sensor (5). When the refilling bottle becomes empty, air comes up the water pipe (11) and water level in the expansion unit (4) will decrease, at a lower rate than in the pipe. Low water level causes the sensor (5) to send a signal to the electronic controller (7) consequently stops the process.

The water level sensor (5) can be made of two tiny electrodes that lay in a very narrow sleeve positioned at the top of the expansion unit (4) or by a small floating ball closing a circuit when reaching the bottom of the sensor sleeve. Water will not flow through the sensor and the water will not be ionized in any manner.

Optionally, it is possible, but not mandatory, to insert two more electrodes (6) to the “fixed” bottle (9) setting maximum and minimum water level sensors. Those sensors can be connected to the electronic controller (7) and activate (min. level) or deactivate (max. level) the filling process.

The electronic controller (7) is electronically based controller, supervising the various sensors (5,6), the air-pump (2), the pressure release valve (3) and the command panel (8) which is the interface between the user/consumer and the controller.

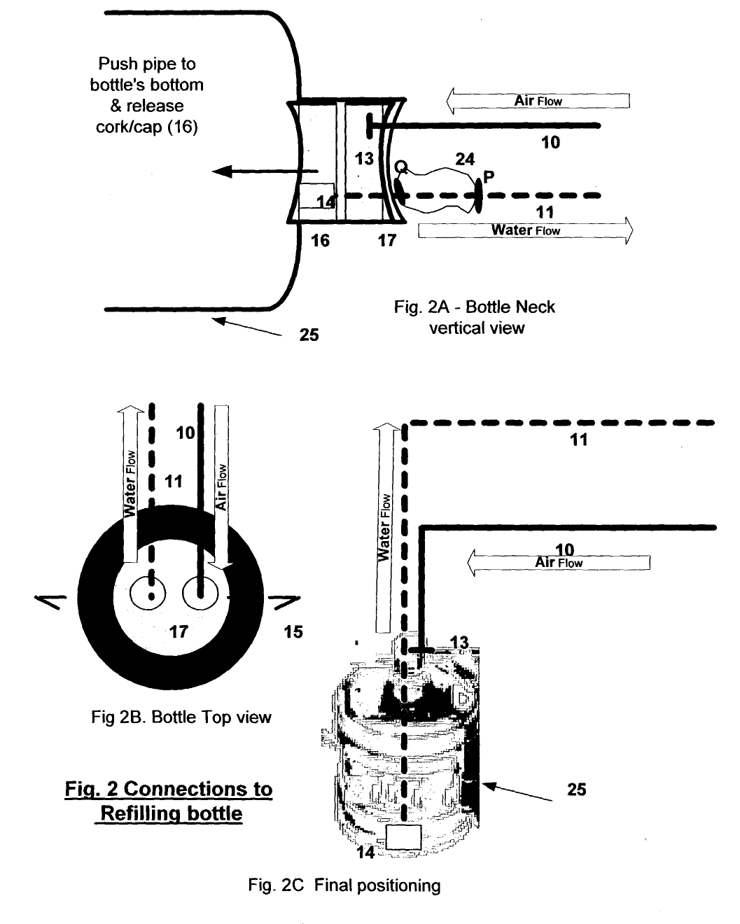

Referring to FIG. 2, the invention provides the way to easily connect the air pipe (10) and the water pipe (11), from/to the system at the cooler (as in FIG. 1 connectors 26+27), to/from the refilling bottle (25), respectively. There is no actual limit to the length of the pipe; therefore the refilling bottles can be store in any convenient corner within user facilities.

FIG. 2A shows the initial state inserting the pipes.

Pipes, at their ends, are constantly combined with a cap (17), same or similar to the cap sealing the inner side of the bottle neck (16) as described in the appropriate mentioned US patents.

The air pipe is connected in a static, non-movable, way to the cap (17) whilst at the end there is a simple stainless steel, or other material, clip (13). Tasks of that clip (13) are to hold the air pipe in its place and assist in releasing the outer cap (17) for re-use.

The water pipe is inserted to the cap (17) via a rubber grommet, which allows it to be moved inward and outward whilst sealing it completely. At the end of the water pipe attached a small clip (14). Tasks of this clip (14) are: 1. Assist in releasing the inner cap (16) and opening the bottle for water-pipe path. 2. Serve as a small weight to the pipe in order to assure it will reach the bottom of the bottle (25) at the most efficient angle for maximum water draw. 3. Assist in releasing the cap (17) after bottle become empty.

The procedure of inserting the pipes to a sealed water bottle is as follow: 1. Both pipes are drawn back and theirs clips (13+14) are adjoin to the cap (17), from the inside. 2. Cap (17) is inserted to the neck of the bottle from its upward opening. Cap (17) has rubber O ring on it, thus it seals the neck completely and no water will leak out as well as no air pressure. 3. Pushing the water pipe (11) to the bottom of the bottle (25) whilst using clip (14) to push the inner cap (16) inside the bottle and opening the desired path for the pipe.

A special attention is given to the cleanness of the water pipe (11), as it gets inside the water bottle into the water, by a flexible, stretched cover (24). This cover (24) is connected in one side (P) to the pipe (11), at a point that will be closest to the bottle (25) top whilst pipe end is at the bottom of the bottle. On the other side (Q), the cover (24) is connected to the cap (17).

This way, while pulling the water pipe out of the bottle, for displacing pipes to another refilling bottle, the portion of it that gets into the water, will not be exposed to the open air or any other potential dirt/contamination.

FIG. 2B describes, in a top perspective, the pipes (10+11) and the cap (17). A secure element (15) may be added to add extra assurance for keeping the bottle opening sealed by the cap (17). This element is a, double or single, U shape with extensions, seats on bottleneck and holds the cap (17).

FIG. 2C Presents the final stage after inserting the pipes correctly. Bottle (25) can be positioned in any desired angle, e.g. on its side; on a special stand with any desirable angle; etc.

As pressured air comes in to the bottle by air pipe (10), water is forced to come up the water pipe (11) and flow toward the mounted bottle (9) on the water cooler via connector (27) and expansion unit (4) (see FIG. 1).

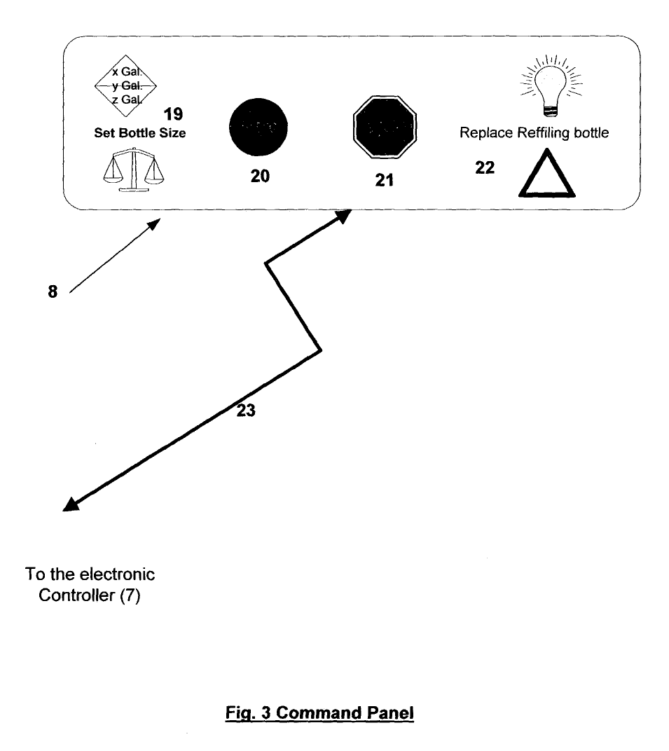

FIG. 3 presents the command panel (8). This panel enables the user/consumer to control the operation. By cable (23) it connects to the electronic controller (7).

The panel consists of:

A bottle size switch-selector (19). It enables the user to set the appropriate time-out limit for the filling operation, according to the size of a bottle on top of the cooler. After this selected pre-programmed time, from operation start time, the operation will cease as sufficient water quantity had flown to the “fixed” bottle.

It is possible, sometimes preferable, to place the smallest available bottle size on the cooler, for aesthetic reasons, whilst the refilling bottle will be the biggest, for transportation efficiency. The switch can be programmed to any available size e.g. 5 Gal./3 Gal./1 Gal. Etc.

A Start button (20). This button starts the filling operation, in manual mode.

A Stop button (21). This button stops the filling operation, in manual mode.

A warning indicator—lamp and/or display. This warning indicates the user that filling bottle is empty and it's time to connect the pipes to another water-full bottle.

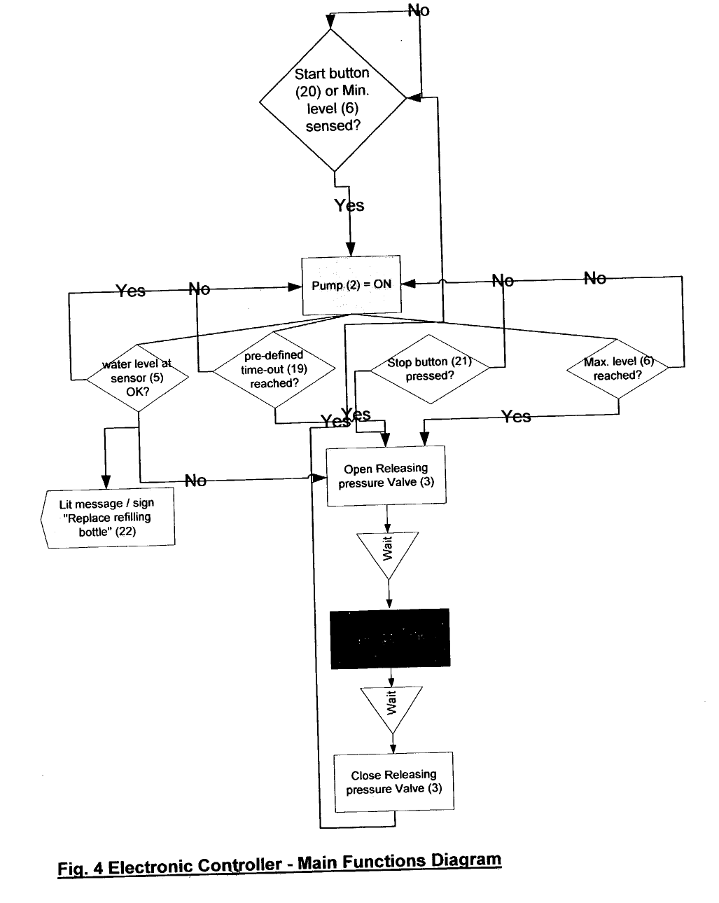

FIG. 4 presents the principals of main functions done by the electronic controller (8). It's self-explanatory as it controls all possible states, to perform smooth straightforward operation. Different implementations of the controller functions have no influence to the invention as long as it complies with the logic contained hereby.

What is claimed is:

1. A refill system, from bottle to bottle, for water bottle mounted in an inverted orientation to an upwardly open water reservoir of a bottled water cooler, said system comprising:
a. An air-pump, electronically controlled, which sucks air from mounted bottle and press air to a water-full bottle, located in any distance from the water cooler, via commonly used air pipes;
b. A pressure-release valve, electronically controlled;
c. Water pipe that is inserted on one end into a water-full bottle, i.e. a refilling bottle, and on the other end to the bottle mounted on top of the water cooler;
d. An electronic controller, which controls the air-pump and the pressure release valve operations whilst responses to a command panel, activated by a user, and set of sensors monitoring water levels at said mounted bottle and water pipe;
e. A cap that hermetically seals a water-full bottle, with a compatible rubber “O” ring, allowing air pipe and water pipe to be inserted into the bottle.

2. The refill system of claim 1, said mounted bottle being modified with two holes, allowing air pipe and water pipe to be inserted inward the bottle, being hermetically sealed by rubber grommet ring.

3. The refill system of claim 1, wherein the airflow from said bottle is directed to only out-flow by a unidirectional valve prohibiting any air flow inward the bottle.

4. The refill system of claim 1, wherein said water pipe is connected to an expansion unit or sleeve which also act as a place to install water flow sensor and a mean to eliminate air flow from said mounted bottle.

5. The refill system of claim 1, wherein said water pipe is further provided with a flexible, stretched cover connected to its portion adjoin the said sealing cap of a water-full bottle, keeping this portion in an isolated environment whilst not inside a bottle.

6. The refill system of claim 1, wherein said water pipe is further provided with a clip or any other device at the end of the pipe, acting as a weight directing the tip of the pipe to the lowest point in the water full bottle, taking advantage of gravity, for most efficient water withdrawal and also as a mean to release the inner sealing cap of that bottle.

7. The refill system of claim 1, said command panel further provided means to activate and deactivate the refilling operation as well as setting refilled bottle size and any related indications to a user.

8. The refill system of claim 1, said mounted bottle being modified to include water level sensors that indicate its status to said electronic controller.

9. The refill system of claim 1, said cap sealing water-full bottle further provided with a clip surrounding that bottle neck and applying pressure on said cap to assure complete sealing.

10. The refill system according to any claims 1-9 substantially as described hereinabove.

11. The refill system according to any claims 1-9 substantially as illustrated in any of the drawings or illustrations or figures, as attached.
